(19) United States
(12) Patent Application Publication
(10) Pub. No.: US 2014/0125671 A1
(43) Pub. Date: May 8, 2014

(54) System and Method for Detailed Automated Feature Extraction from Data Having Spatial Coordinates

(71) Applicants: Borys Vorobyov, Gloucester (CA); Oleksandr Monastyrev, Kharkiv (UA); Dmitry Kulakov, Ottawa (CA); Edmund Cochrane Reeler, Ottawa (CA)

(72) Inventors: Borys Vorobyov, Gloucester (CA); Oleksandr Monastyrev, Kharkiv (UA); Dmitry Kulakov, Ottawa (CA); Edmund Cochrane Reeler, Ottawa (CA)

(21) Appl. No.: 13/824,101

(22) PCT Filed: Sep. 15, 2011
(86) PCT No.: PCT/CA2011/050566

§ 371 Date: Jun. 10, 2013

Related U.S. Application Data
(60) Provisional application No. 61/383,632, filed on Sep. 16, 2010.

(51) Int. Cl. G06T 17/00

(52) U.S. Cl. CPC G06T 17/00
USPC 345/427

(57) ABSTRACT

Systems and methods are provided for extracting features of a building from data having spatial coordinates. The method includes extracting one or more walls and roofs from the data; constructing a building model from the walls and roofs; extracting color data associated with the data and projecting the color data onto the building model; superimposing one or more images onto the building model; applying pattern recognition to extract one or more three-dimensional structural components of the building model; replacing identified three-dimensional structural components with the standard structural elements; comparing subsequent data sets to identify a changed object; and, extracting one or more poles in the building model's vicinity or along the edges of roads.

### CROSS-REFERENCE TO RELATED APPLICATIONS

This application claims priority from U.S. Provisional Application No. 61/383,632, filed on Sep. 16, 2010, the entire contents of which are incorporated herein by reference.

### TECHNICAL FIELD

The following relates generally to manipulating data representing spatial coordinates.

### DESCRIPTION OF THE RELATED ART

In order to investigate an object or structure, it is known to interrogate the object or structure and collect data resulting from the interrogation. The nature of the interrogation will depend on the characteristics of the object or structure. The interrogation will typically be a scan by a beam of energy propagated under controlled conditions. The results of the scan are stored as a collection of data points, and the position of the data points in an arbitrary frame of reference is encoded as a set of spatial-coordinates. In this way, the relative positioning of the data points can be determined and the required information extracted from them.

Data having spatial coordinates may include data collected by electromagnetic sensors of remote sensing devices, which may be of either the active or the passive types. Non-limiting examples include LiDAR (Light Detection and Ranging), RADAR, SAR (Synthetic-aperture RADAR), IFSAR (Interferometric Synthetic Aperture Radar) and Satellite Imagery. Other examples include various types of 3D scanners and may include sonar and ultrasound scanners.

LiDAR refers to a laser scanning process which is usually performed by a laser scanning device from the air, from a moving vehicle or from a stationary tripod. The process typically generates spatial data encoded with three dimensional spatial data coordinates having XYZ values and which together represent a virtual cloud of 3D point data in space or a “point cloud”. Each data element or 3D point may also include an attribute of intensity, which is a measure of the level of reflectance at that spatial data coordinate, and often includes attributes of RGB, which are the red, green and blue color values associated with that spatial data coordinate. Other attributes such as first and last return and waveform data may also be associated with each spatial data coordinate. These attributes are useful both when extracting information from the point cloud data and for visualizing the point cloud data. It can be appreciated that data from other types of sensing devices may also have similar or other attributes.

The visualization of point cloud data can reveal to the human eye a great deal of information about the various objects which have been scanned. Information can also be manually extracted from the point cloud data and represented in other forms such as 3D vector points, lines and polygons, or as 3D wire frames, shells and surfaces. These forms of data can then be input into many existing systems and workflows for use in many different industries including for example, engineering, architecture, construction and surveying.

A common approach for extracting these types of information from 3D point cloud data involves subjective manual pointing at points representing a particular feature within the point cloud data either in a virtual 3D view or on 2D plans, cross sections and profiles. The collection of selected points is then used as a representation of an object. Some semi-automated software and CAD tools exist to streamline the manual process including snapping to improve pointing accuracy and spline fitting of curves and surfaces. Such a process is tedious and time consuming. Accordingly, methods and systems that better semi-automate and automate the extraction of these geometric features from the point cloud data are highly desirable.

Automation of the process is, however, difficult as it is necessary to recognize which data points form a certain type of object. For example, in an urban setting, some data points may represent a building, some data points may represent a tree, and some data points may represent the ground. These points coexist within the point cloud and their segregation is not trivial.

From the above it can be understood that efficient and automated methods and systems for identifying and extracting features from 3D spatial coordinate data are highly desirable.

### BRIEF DESCRIPTION OF THE DRAWINGS

Embodiments of the invention or inventions will now be described by way of example only with reference to the appended drawings wherein:

FIG. 1 is a schematic diagram to illustrate an example of an aircraft and a ground vehicle using sensors to collect data points of a landscape.

FIG. 2 is a block diagram of an example embodiment of a computing device and example software components.

FIG. 3 is a flow diagram illustrating example computer executable instructions for constructing a building model using data from a point cloud.

FIG. 4 is a schematic diagram illustrating an example stage in the method for reconstructing a building model, showing the decomposition of points that belong to a building into spatial tiles.

FIG. 5 is a schematic diagram illustrating an example stage in the method for reconstructing a building model, showing the normal vectors of the spatial tiles.

FIG. 6 is a schematic diagram illustrating an example stage in the method for reconstructing a building model, showing the identification of flat areas within each wall.

FIG. 7 is a schematic diagram illustrating an example stage in the method for reconstructing a building model, showing a wall shell.

FIG. 8 is a schematic diagram illustrating an example stage in the method for reconstructing a building model, showing a generalized wall shell.

FIGS. 9 and 10 are schematic diagrams illustrating example methods to patch holes in the point cloud data when reconstructing a building model.

FIG. 11 is a flow diagram illustrating example computer executable instructions for colorizing a building model constructed from point cloud data.

FIG. 12 is a schematic diagram illustrating an example stage in the method for colorizing a building model, showing a projection plane of a wall of the building model.

FIG. 13 is a schematic diagram illustrating an example stage in the method for colorizing a building model, showing the data points belonging to a structural unit projected to a projection plane.

FIGS. 14 and 15 are schematic diagrams illustrating an example stage in the method for colorizing a building model, showing the projection of each unit of resolution of the wall model on the pixels of the raster image on the projection plane.

FIG. 16 is a schematic diagram illustrating example stages in the process of preparing texture image components for draping over building models.

FIG. 17 is a flow diagram illustrating example computer executable instructions for preparing texture image components to be draped over 3D polygonal building model facets.

FIG. 18 is a flow diagram illustrating example computer executable instructions for automated pattern recognition used to identify structural elements of a high resolution polygonal 3D building model.

FIGS. 19 to 25 are schematic diagram illustrating example stages in the method for automated pattern recognition used to identify structural elements of a high resolution polygonal 3D building model.

FIG. 26 is a flow diagram illustrating example computer executable instructions for automating the process of computerized 3D building model enhancement by replacing similar 3D structural elements in the model with a pre-built template of that element.

FIG. 27 is a flow diagram illustrating example computer executable instructions for automated identification of a moving object.

FIG. 28 is a schematic diagram illustrating example stages in the process of extracting poles along the roads from point could data.

FIG. 29 is a flow diagram illustrating example computer executable instructions for extracting poles along the roads from point cloud data.

### DETAILED DESCRIPTION

It will be appreciated that for simplicity and clarity of illustration, where considered appropriate, reference numerals may be repeated among the figures to indicate corresponding or analogous elements. In addition, numerous specific details are set forth in order to provide a thorough understanding of the embodiments described herein. However, it will be understood by those of ordinary skill in the art that the embodiments described herein may be practiced without these specific details. In other instances, well-known methods, procedures and components have not been described in detail so as not to obscure the embodiments described herein. Also, the description is not to be considered as limiting the scope of the embodiments described herein.

The proposed systems and methods extract various features from data having spatial coordinates. Non-limiting examples of such features include the ground surface, buildings, building shapes, vegetation, and power lines. The extraction of the features may be carried out automatically by a computing device. The extracted features may be stored as objects for retrieval and analysis.

As discussed above, the data may be collected from various types of sensors. A non-limiting example of such a sensor is the LiDAR system built by Ambercore Software Inc. and available under the trade-mark TITAN.

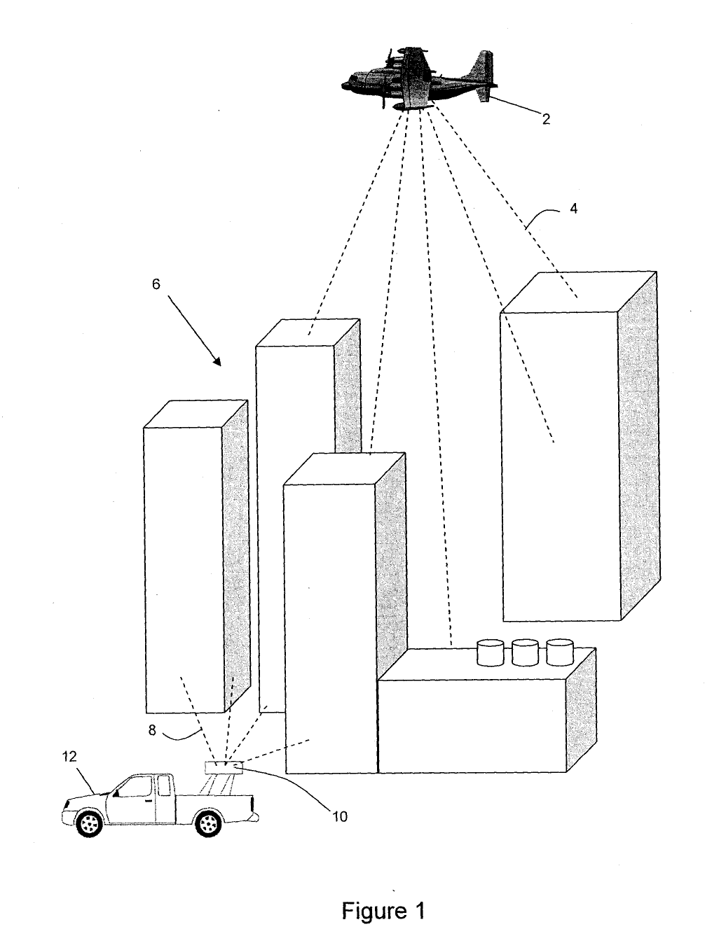

Turning to FIG. 1, data is collected using one or more sensors 10 mounted to an aircraft 2 or to a ground vehicle 12. The aircraft 2 may fly over a landscape 6 (e.g. an urban landscape, a suburban landscape, a rural or isolated landscape) while a sensor collects data points about the landscape 6. For example, if a LiDAR system is used, the LiDAR sensor 10 would emit lasers 4 and collect the laser reflection. Similar principles apply when an electromagnetic sensor 10 is mounted to a ground vehicle 12. For example, when the ground vehicle 12 drives through the landscape 6, a LiDAR system may emit lasers 8 to collect data. It can be readily understood that the collected data may be stored onto a memory device. Data points that have been collected from various sensors (e.g. airborne sensors, ground vehicle sensors, stationary sensors) can be merged together to form a point cloud.

Each of the collected data points is associated with respective spatial coordinates which may be in the form of three dimensional spatial data coordinates, such as XYZ Cartesian coordinates (or alternatively a radius and two angles representing Polar coordinates). Each of the data points also has numeric attributes indicative of a particular characteristic, such as intensity values, RGB values, first and last return values and waveform data, which may be used as part of the filtering process. In one example embodiment, the RGB values may be measured from an imaging camera and matched to a data point sharing the same coordinates.

The determination of the coordinates for each point is performed using known algorithms to combine location data, e.g. GPS data, of the sensor with the sensor readings to obtain a location of each point with an arbitrary frame of reference.

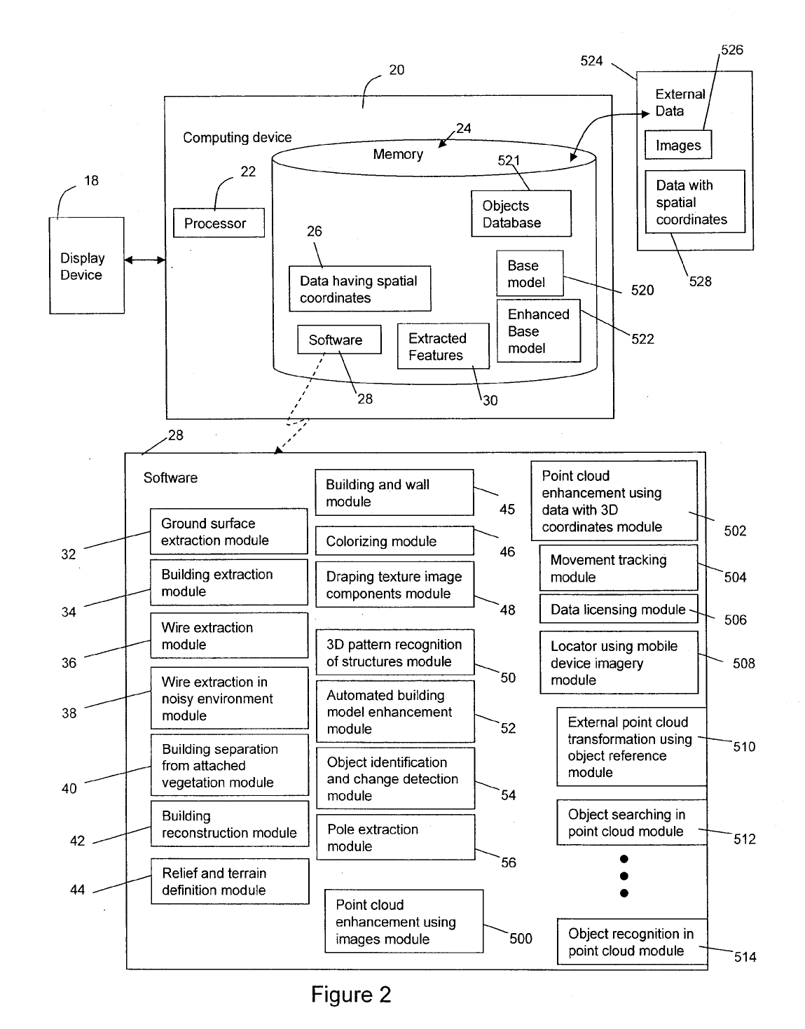

Turning to FIG. 2, a computing device 20 includes a processor 22 and memory 24. The memory 24 communicates with the processor 22 to process data. It can be appreciated that various types of computer configurations (e.g. networked servers, standalone computers, cloud computing, etc.) are applicable to the principles described herein. The data having spatial coordinates 26 and various software 28 reside in the memory 24. A display device 18 may also be in communication with the processor 22 to display 2D or 3D images based on the data having spatial coordinates 26.

It can be appreciated that the data 26 may be processed according to various computer executable operations or instructions stored in the software. In this way, the features may be extracted from the data 26.

Continuing with FIG. 2, the software 28 may include a number of different modules for extracting different features from the data 26. For example, a ground surface extraction module 32 may be used to identify and extract data points that are considered the “ground”. A building extraction module 34 may include computer executable instructions or operations for identifying and extracting data points that are considered to be part of a building. A wire extraction module 36 may include computer executable instructions or operations for identifying and extracting data points that are considered to be part of an elongate object (e.g. pipe, cable, rope, etc.), which is herein referred to as a wire. Another wire extraction module 38 adapted for a noisy environment 38 may include computer executable instructions or operations for identifying and extracting data points in a noisy environment that are considered to be part of a wire. The software 28 may also include a module 40 for separating buildings from attached vegetation. Another module 42 may include computer executable instructions or operations for reconstructing a building. There may also be a relief and terrain definition module 44.

A building and wall construction module 45 includes computer executable instructions for constructing a building from point cloud data based on the identification of walls. A colorizing module 46 includes computer executable instructions for colorizing a building model constructed from point cloud data. A preparing texture image components module 48 includes computer executable instructions for preparing texture image components to be draped over 3D polygonal building model facets. An automated pattern recognition module 50 includes computer executable instructions for automated pattern recognition used to identify structural elements of a high resolution polygonal 3D building model. An automated building model enhancement module 52 includes computer executable instructions for automating the process of computerized 3D building model enhancement by replacing similar 3D structural elements in the model with a pre-built 3D template of that element. An automated identification moving object module 54 includes computer executable instructions for automated identification of a moving object. An extraction pole module 56 includes computer executable instructions for extracting poles along the roads from point cloud data.

It can be appreciated that there may be many other different modules for extracting features from the data having spatial coordinates 26.

Continuing with FIG. 2, the features extracted from the software 28 may be stored as data objects in an “extracted features” database 30 for future retrieval and analysis. For example, features (e.g. buildings, vegetation, terrain classification, relief classification, power lines, etc.) that have been extracted from the data (e.g. point cloud) 26 are considered separate entities or data objects, which are stored the database 30. It can be appreciated that the extracted features or data objects may be searched or organized using various different approaches.

Also shown in the memory 24 is a database 520 storing one or more base models. There is also a database 522 storing one or more enhanced base models. Each base model within the base model database 520 comprises a set of data having spatial coordinates, such as those described with respect to data 26. A base model may also include extracted features 30, which have been extracted from the data 26. As will be discussed later below, a base model 522 may be enhanced with external data 524, thereby creating enhanced base models. Enhanced base models also comprise a set of data having spatial coordinates, although some aspect of the data is enhanced (e.g. more data points, different data types, etc.). The external data 524 can include images 526 (e.g. 2D images) and ancillary data having spatial coordinates 528.

An objects database 521 is also provided to store objects associated with certain base models. An object, comprising a number of data points, a wire frame, or a shell, has a known shape and known dimensions. Non-limiting examples of objects include buildings, wires, trees, cars, shoes, light poles, boats, etc. The objects may include those features that have been extracted from the data having spatial coordinates 26 and stored in the extracted features database 30. The objects may also include extracted features from a base model or enhanced base model.

FIG. 2 also shows that the software 28 includes a module 500 for point cloud enhancement using images. The software 28 also includes a module 502 for point cloud enhancement using data with 3D coordinates. There may also be a module 504 for movement tracking (e.g. monitoring or surveillance). There may also be another module 506 for licensing the data (e.g. the data in the databases 25, 30, 520 and 522). The software 28 also includes a module 508 for determining the location of a mobile device or objects viewed by a mobile device based on the images captured by the mobile device. There may also be a module 510 for transforming an external point cloud using an object reference, such as an object from the objects database 521. There may also be a module 512 for searching for an object in a point cloud. There may also be a module 514 for recognizing an unidentified object in a point cloud. It can be appreciated that there may be many other different modules for manipulating and using data having spatial coordinates. It can also be understood that many of the modules described herein can be combined with one another.

It will be appreciated that any module or component exemplified herein that executes instructions or operations may include or otherwise have access to computer readable media such as storage media, computer storage media, or data storage devices (removable and/or non-removable) such as, for example, magnetic disks, optical disks, or tape. Computer storage media may include volatile and non-volatile, removable and non-removable media implemented in any method or technology for storage of information, such as computer readable instructions, data structures, program modules, or other data, except transitory propagating signals per se. Examples of computer storage media include RAM, ROM, EEPROM, flash memory or other memory technology, CD-ROM, digital versatile disks (DVD) or other optical storage, magnetic cassettes, magnetic tape, magnetic disk storage or other magnetic storage devices, or any other medium which can be used to store the desired information and which can be accessed by an application, module, or both. Any such computer storage media may be part of the computing device 20 or accessible or connectable thereto. Any application or module herein described may be implemented using computer readable/executable instructions or operations that may be stored or otherwise held by such computer readable media.

Details regarding the different feature extraction systems and methods, that may be associated with the various modules in the software 28, will now be discussed.

The present invention provides a method to construct a 3D spatial data shell which approximates, within the required precision, the outer surface of a building, using as input a collection of spatial data points from a point cloud. The method is based on constructing a piecewise-continuous model of the building. It is assumed that the outer surface of each building constitutes large planar pieces connected at their edges by relatively smaller elements. Together they form a shell of facets which can be colored by superimposing colored images.

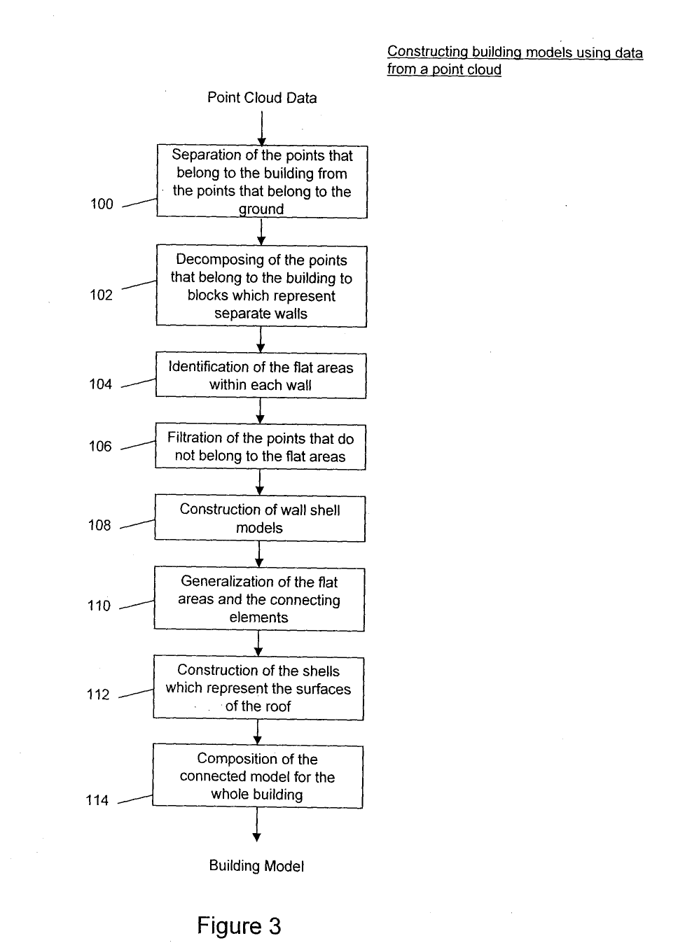

Turning to FIG. 3, example computer executable instructions are provided for constructing a building model using data from a point cloud (e.g. according to module 45). At block 100, points that belong to the building are separated from the points that belong to the ground. First the input collection of data from a point cloud must be pre-processed to identify and extract an approximate ground surface and associated Digital Terrain Model for the whole area of interest. The remaining set of points describing features above the ground is then filtered to extract those points that represent buildings only and that lie within the building footprint and above the ground surface. Examples of these procedures are described in associated patent applications: U.S. 61/319,785, SYSTEM AND METHOD FOR EXTRACTING FEATURES FROM DATA HAVING SPATIAL COORDINATES and U.S. 61/353,939, SYSTEM AND METHOD FOR MANIPULATING DATA HAVING SPATIAL COORDINATES, which are herein incorporated by reference in their entirety.

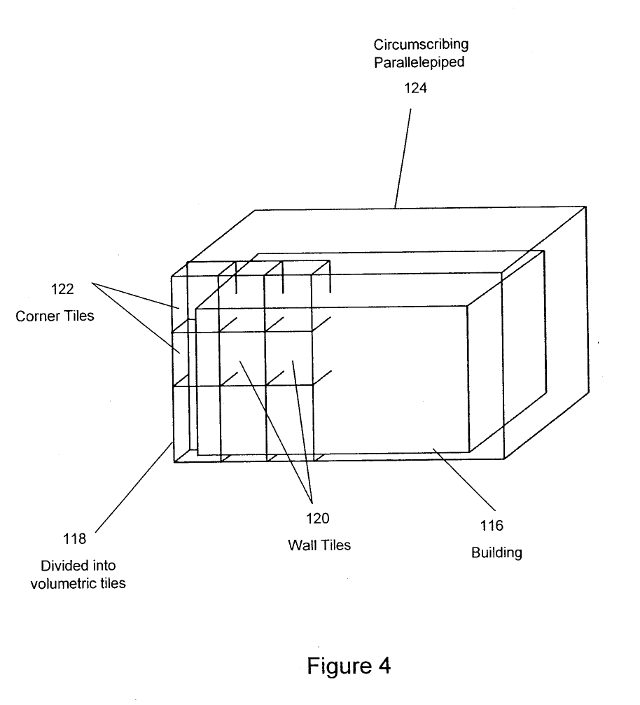

At block 102, the points that belong to the building are decomposed to blocks which represent separate walls. It is supposed that the points belonging to the same wall are mostly located within flat contiguous zones having closely oriented normal vectors. In order to find these zones, the whole 3-dimensional extent of the building data points (i.e. the parallelepiped circumscribing all data points representing the building) is divided into small cubes or spatial volumetric tiles (for example having a side of about 1 m). Using this tiling structure the data points are divided into subsets corresponding to each spatial tile. As an example, FIG. 4 shows a parallelepiped 124 circumscribing all data points representing the building 116. The parallelepiped 124 is divided into spatial tiles 118. Individual surfaces 120 of a spatial tile 118 that face away from the building are wall tiles. Surfaces 122 at the corner of a building are corner tiles.

For each of these cubic spatial tiles 118 one builds a co-variation distribution matrix [3×3] of the X Y Z coordinates of the data points in each tile and finds the eigenvalues and eigenvectors.

$${A}_{i , j} = \frac{1}{n} {\sum }_{k = 1 , … , n} {x}_{k}^{i} \cdot {x}_{k}^{j} - \frac{1}{n} {\sum }_{k = 1 , … , n} {x}_{k}^{i} \cdot \frac{1}{n} {\sum }_{k = 1 , … , n} {x}_{k}^{j}$$

where n is the number of points inside the circumscribed parallelepiped;
i,j=1, 2, 3;
xₖ¹ xₖ² xₖ³
are the (X, Y, Z) coordinates of the k^{th} point

If one of the eigenvalues is significantly less than the two others then it is assumed that the data points within this spatial tile 118 represent a flat part of the building surface and the normal vector of the constructed plane is defined by the eigenvector associated with the smallest eigenvalue.

The tiles and their data points are placed into groups of tiles having the same or closely similar directions of their normal vectors, and also whereby the tiles are contiguous. This is a recursive iterative process in that the normal vector of each group of tiles is re-calculated as the average weighted value of all normal vectors of the tiles which have been already included into the group. Each group of tiles aggregated in this way constitutes and represents a separate wall.

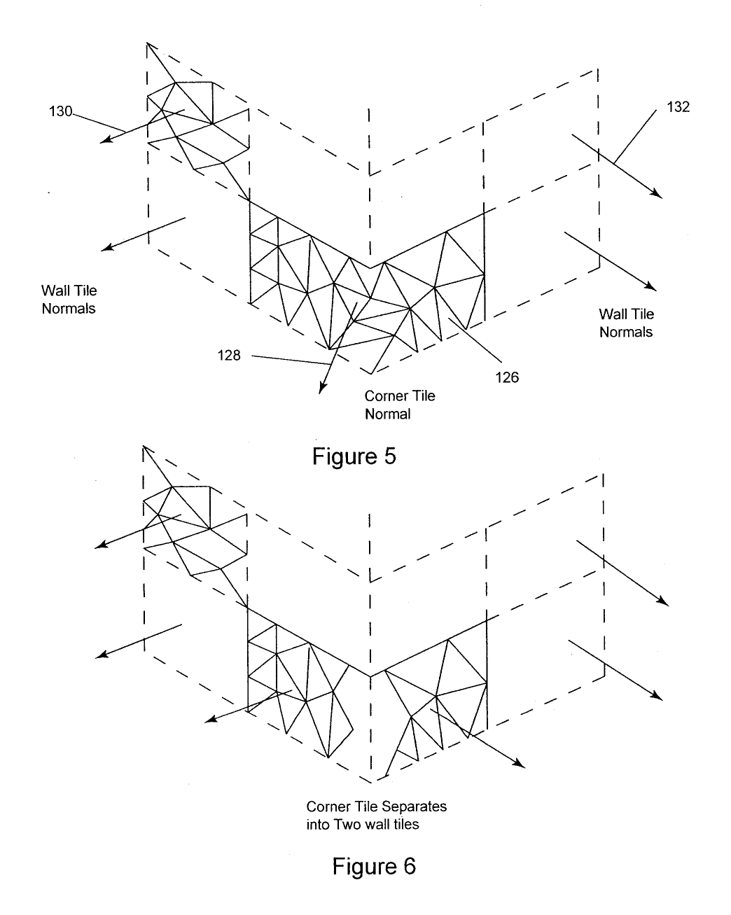

At block 104, the flat areas within each wall are identified. The randomness of decomposition of the original building data points into the smaller spatial tiles 118 will lead to certain ambiguities. For example some points considered as a part of the wall in fact may not belong to it and vice versa. For example, for tiles located on the building corners where two or more walls are connected, one can not reliably define the normal vector so the tile and its related points will not be associated with any wall. As an example, FIG. 5 shows that the normal vector 128 of a corner tile 126 is not in a similar direction as normal vector 130 or 132.

In order to avoid that kind of problem, for each tile not yet associated with any group, one triangulates the data points to create a TIN (Triangulated Irregular Network). Each triangle in the TIN is then analyzed and if its individual normal vector is close to the overall normal vector of the tile the triangle edges are deleted.

This will cause the TIN network to separate into smaller connected areas until each smaller connected area has an average normal vector close to the normal vector of an existing group of tiles representing a wall, thus allowing the smaller connected area to be included into one of the existing wall groups.

The effect of this activity on the TIN networks will also be to break down stand-alone objects connected to the wall (such as flag poles) or just random noise produced either by the data collection device or by random objects (such as signals that return from the inner walls of the building or signals from branches of the trees close to the building etc.) and all of them will be removed from the wall description.

Thus one is left with only those flat areas which have big enough footprint to be considered as a wall and using the points from these areas one builds the triangulation network that can be treated as the first approximation of wall model (FIG. 6). Later on this network will be complemented with non-flat areas.

At block 106, the points that do not belong to the flat areas are filtered. Each group of points associated with a wall in block 104 must now be analyzed and filtered to determine whether they belong to the wall or not.

The principal parameters one uses for this analysis is the normal vector of each group of points and the distance form the main part of the wall. Points greater than a certain perpendicular distance (for example half the length of a tile's dimension) from the main part of the wall are removed from the group representing the wall. This eliminates points such as internal walls measured through windows or points from orthogonal walls accidentally reflected in windows.

The next step of filtration is to classify the points which belong to the tiles which do not have a definitive normal vector. Points within these tiles are analyzed to see if they lie close to the approximate plane of an existing wall. If so then they are added to the groups of points representing these walls. All data points which have not been classified as belong to a certain wall remain in a special class of their own.

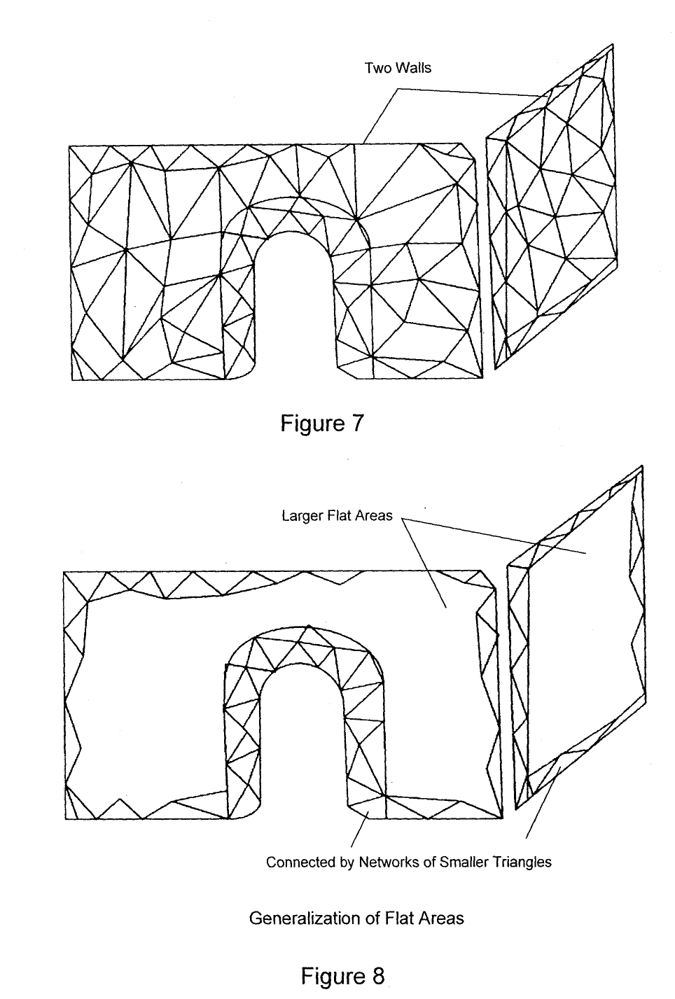

At block 108, the wall shell model is constructed. A wall shell is now constructed separately for each wall by creating a triangulation network using each of the classified groups of wall points (FIG. 7). Sometimes the above described classification of points may lead to an excessive number of groups (walls) depending on the classification parameters which were used. In many cases it may not be desirable to have a large number of walls in a building model if that amount of detail is not necessary. For example it would be very inconvenient and inefficient when draping images over the walls (model colorization).

Therefore the next step is to analyze the area of each wall constructed and to generalize the flat areas by merging the small walls (below a chosen size threshold) with an adjacent bigger wall with the closest normal vector (within a chosen angle threshold) (FIG. 8). At block 110, the flat areas and the connecting elements are generalized.

The increasing high density of data collection using for example laser scanning techniques means that a typical shell one uses to represent the wall may contain an order of magnitude of 1 million data points. This order of magnitude of data volume may not be easy to store, to transmit, to operate with and to display especially taking into account the total number of walls constituting an average big building.

In order to resolve this problem one has to generalize the shell while intelligently controlling and minimizing losses in precision. The principal idea of generalization is based on finding “almost flat” areas within the wall and to reduce the number of elements (nodes and edges in the network shell representing the wall) by the additional flattening of these areas with minimum changes in both the appearance and the geometry of the wall.

One finds flat areas using a recursive iterative algorithm. The process can start from any pair or group of triangles in the TIN. Neighboring triangles which have close normal vectors (within a set threshold of 5 degrees for example) are substituted by a plane calculated with the help of the least squares method. Then one iterates the process and includes the next triangles which neighbor those already processed. Hence the flat area may grow and its normal vector is adjusted at each extension. In this way the whole TIN shell becomes decomposed into larger flat areas connected by a network of smaller triangles (which represent non flat elements of the building shell). See FIG. 8.

Then one projects the boundary points of each flat area to a constructed approximating plane of this area. The inner points of each flat are then deleted and the TIN is rebuilt using only the boundary points of the flat areas as well as the points located outside of flat areas. The constructed shell can be represented either as a TIN-based spatial object (such as a wire frame) or as a free-shape facet based spatial object (such as a CAD based shell or solid).

At block 112, the shells that represent the surfaces of the roof are constructed. The reconstruction of the roof surface can be performed by using aerial LiDAR data similarly to the methodology used for wall reconstruction.

The data points representing the surface of the roof are initially isolated after deleting the vertical edges from the spatial triangulation network. This effectively eliminates or fragments most of the wall components which are removed from the data set.

It is supposed that after deleting the vertical edges the obtained connected parts of the roof that appear are constituted from the set of generally speaking more than one quasi-planar or non-planar piece with arbitrary orientation. Then one finds the flat zones by using a similar method that was described for the walls. On concluding the process, one obtains a shell constituted from large flat facets representing flat or sloping roofs and connected by a network of smaller triangles (representing the non-flat surfaces) in the spatial triangulation network. Note that for simplicity, and because roofs by their nature may have many non vertical sloped or flat components whose normal vectors point in a variety of different directions, each resulting roof network or shell is regarded as adopting the vector directed along the vertical axis (Z) as its final normal vector.

At block 114, the connected model for the whole building is composed. The integrated building shell is composed by assembling the wall shells which have been constructed out of mobile data from a point cloud and roof shells which have been constructed out of aerial data from a point cloud. The assembling is performed by an iterative procedure which “glues” single shells to the already assembled part. Initially one of the larger walls can be chosen to represent the already assembled part. Neighboring fragments to the already assembled part are those fragments whose outer boundaries lie in close proximity to the outer boundary of the already assembled part. The required proximity threshold depends on the initial data density.

Points which belong to the outer boundaries of both entities are then connected together by connecting the edge triangles of their TINs with additional TIN triangles using the criterion of minimum edge length. This ensures that the boundaries of the two TINs are connected in a close and direct way. In this way two shells are connected into one. Then one by one all the other shells are connected until one gets a single united shell representing the building model.

Concluding the process described above, one builds a shell consisting of flat facets interconnected by non-flat surfaces which are composed of spatial triangulation networks.

An embodiment of the present invention can address complications in constructing a building model using data from a point cloud. The collection of point cloud data from both aerial and mobile (e.g. LiDAR data collected from a moving vehicle) methods may result in duplication of info (for instance it happens at steep roofs). Duplication of data can be usually resolved either by the direct fusion of aerial and mobile data in certain areas or by ignoring the less precise (lower density) part of data in the ambiguous areas. The actual choice depends on the quality of mutual geo-reference. More specifically if the difference in coordinates for two identical points taken from aerial and mobile data is bigger than the required precision of texture reconstruction then it is better to sacrifice part of data than to worsen the quality of reconstruction.

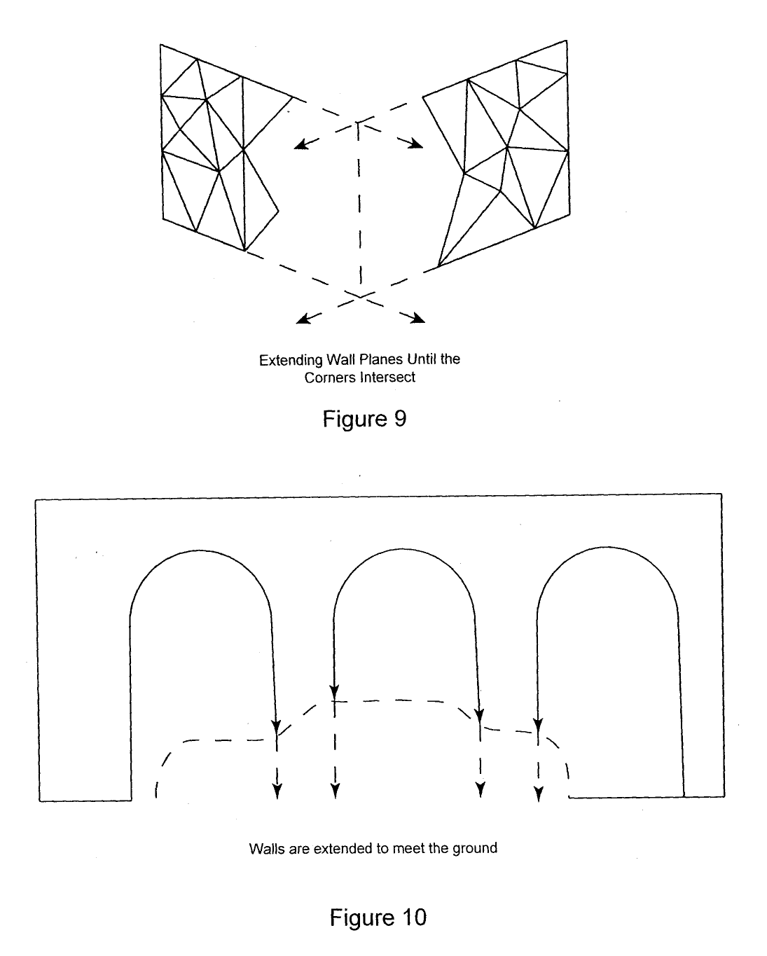

The collection of point cloud data may result in absence of measurements at some parts of the buildings (for instance some parts of building could be obstructed for example by parked cars, also glassed window openings can provide distorted signals). For mending holes caused by the absence of measurements or low density measurements one has to analyze the outer (boundary) edges of the constructed shell. If most of the boundary edges consist of a relatively flat closed contour (for example the frame of a window) then it can be closed by a flat element. If the closed contour is not flat it could be approximated and closed by patching the hole in the triangulation network. If some non-flat contour is located at the border of two flat zones (such as a hole near the corner of the building) then it could be possible to patch the hole by extending the adjacent wall planes until they intersect (to reconstruct the corner of the building) (FIG. 9).

Typically, inner courtyard data has lower quality. For unclosed contours (say with the edges poking into the ground) it becomes a challenge to differentiate if there is a real gap in the data or not (for example an archway whose base has been blocked by a parked car). To truly resolve that kind of rare ambiguities one would need to have additional information. However in the absence of additional information one can close those types of holes by creating vertical walls which run from the unclosed contour edges to the ground surface (FIG. 10).

Another aspect of the present invention provides a method to colorize a building model constructed from point cloud data. Color information is being taken from one of the attribute fields such as RGB or Intensity which accompanied each and every point of the input point cloud data which was used to create the building model shells. For each building model, colorization images are prepared independently for each roof and each wall.

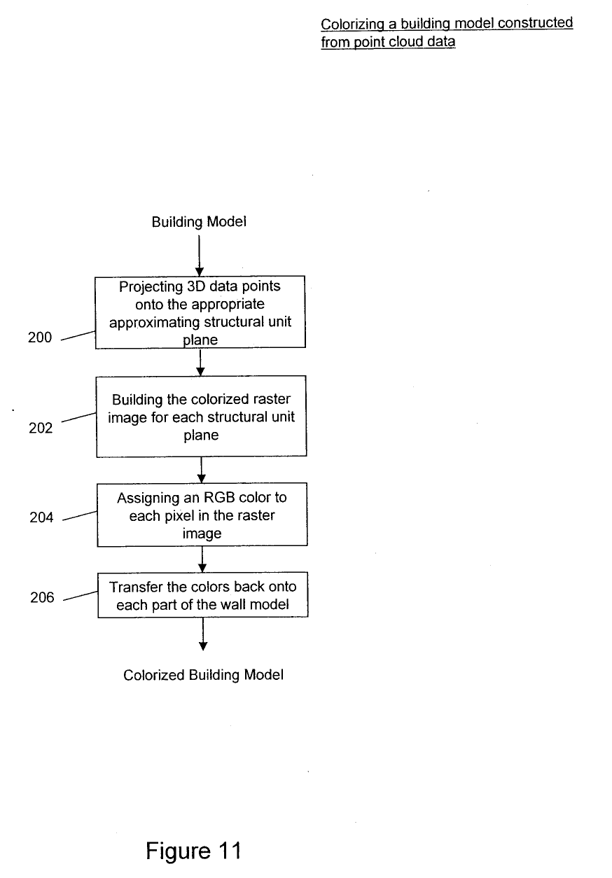

Turning to FIG. 11, example computer executable instructions are provided for colorizing a building model constructed from point cloud data (e.g. according to module 46). It is assumed that a building model has been constructed using data from a point cloud. At block 200, points related to a certain structural unit (of a roof or a wall) of the building model are projected perpendicularly onto the plane comprising this unit (orthogonal to the unit normal vector).

For each wall and roof (unit plane) of a building a normal vector is defined. As previously described in the method to construct building models using data from a point cloud, each wall has an associated normal vector calculated during its creation and each roof adopts the vector directed along the vertical (Z) axis as its normal vector.

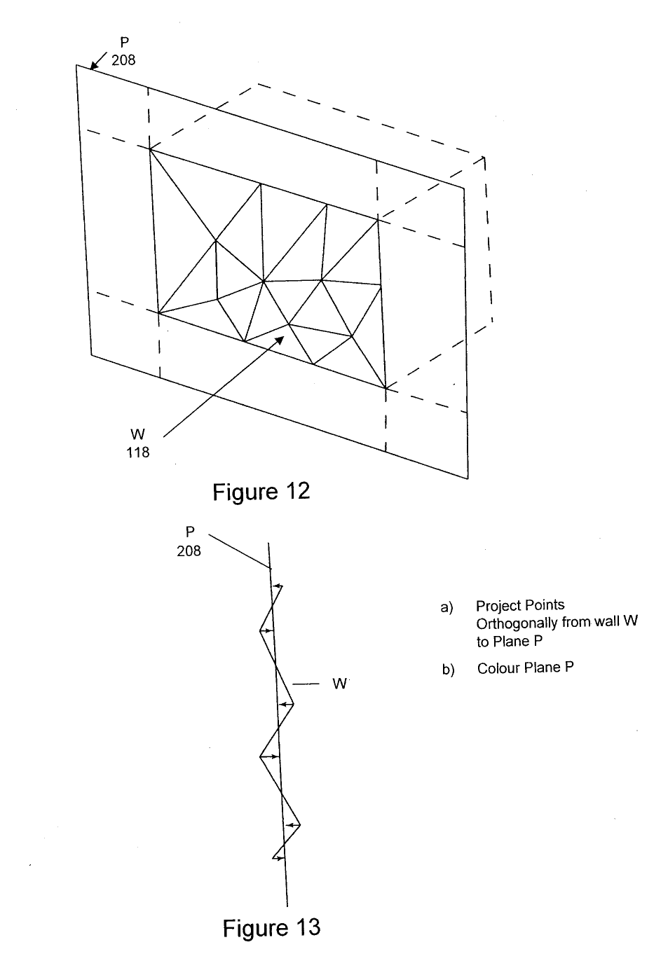

For each wall and roof (unit plane) a projection plane is defined. As shown in FIG. 12, a projection plane 208 for a wall 210 is defined as the plane orthogonal to the normal vector of the wall with Y axis directed along the projection of the vertical (Z) axis of the building to the projection plane.

The projection plane for the roofs is defined as the horizontal plane with geographical coordinate axes.

As shown in FIG. 13, all 3D data points which are classified as belonging to a certain structural unit and from which the structural unit model was created are projected to the projecting plane 208. From their positions on the projecting plane 208 they will be used to colorize an image associated with the structural unit (wall or roof).

At block 202, a colorized raster image for each structural unit plane is built. The extent for all projected points on the projection plane 208 of a structural unit is used to define the perimeter of the image to be generated with the required resolution. The resolution of the image pixels should be several times smaller than the resolution of the data points.

At block 204, each pixel in the created raster image gets assigned an RGB color. Using the projected points one builds a triangulation network on the projected plane. For each raster pixel of the image being created one calculates the RGB value (or intensity value or other attribute value) by applying a linear interpolation of the colors taken from the 3 vertices of the triangle in which the pixel lies. Other types of interpolation include inverse distance, inverse square distance and nearest neighbour.

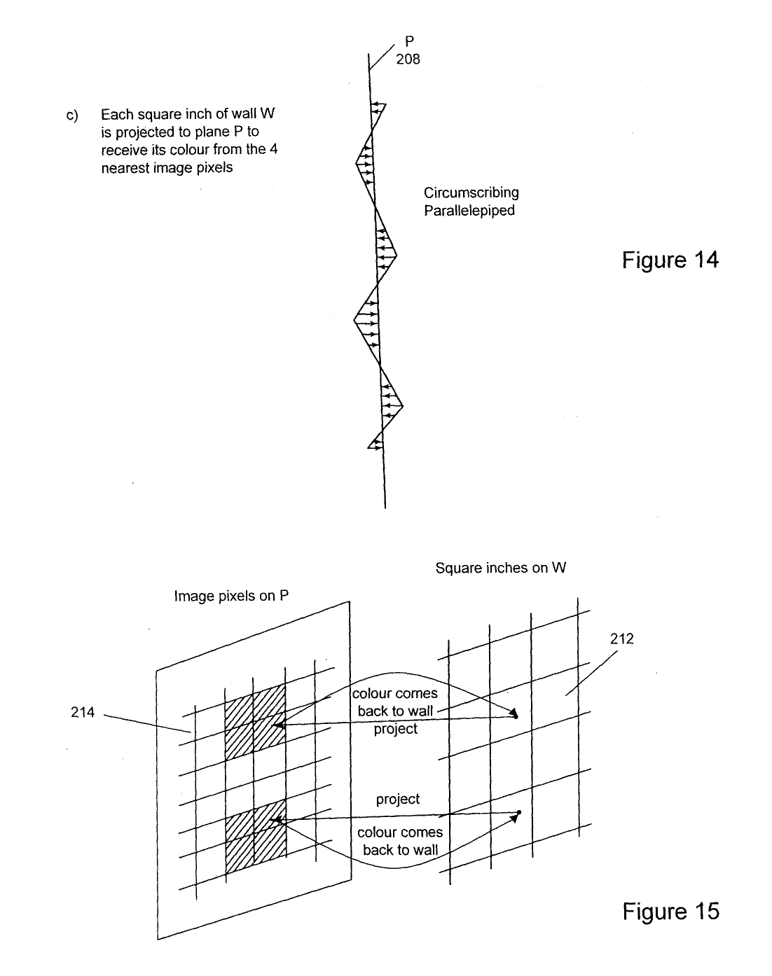

At block 206, the colorized raster image on the projection plane is transferred back onto the 3D model of the wall or roof. As shown in FIG. 15, the 3D model on the wall or roof is divided into units of resolution 212 of the same order of magnitude as the colorized image pixels 214 on the structural unit plane (for example square inches). One projects each unit of resolution 212 (e.g. square inch) of the wall model back to the image 214 on the projection plane (FIGS. 14 and 15). The four image pixels surrounding the projected point are used to find the color by applying a standard bilinear interpolation formula. This color is then assigned to that unit resolution (e.g. square inch) of the wall or roof.

Another aspect of the present invention provides a method for automated preparation of texture image components to be draped over 3D polygonal building model facets to enhance visual representation of the building model. In order for a 3D polygonal building model to look close to reality its model is usually enhanced with the texture (set of images) draped over all or some of the building model's facets. These images are normally prepared by manual alignment of model facets with pictures of the same building taken from different angles and then cut accordingly. The manual process is time consuming and inaccurate while the proposed method allows for easy automation using a computer.

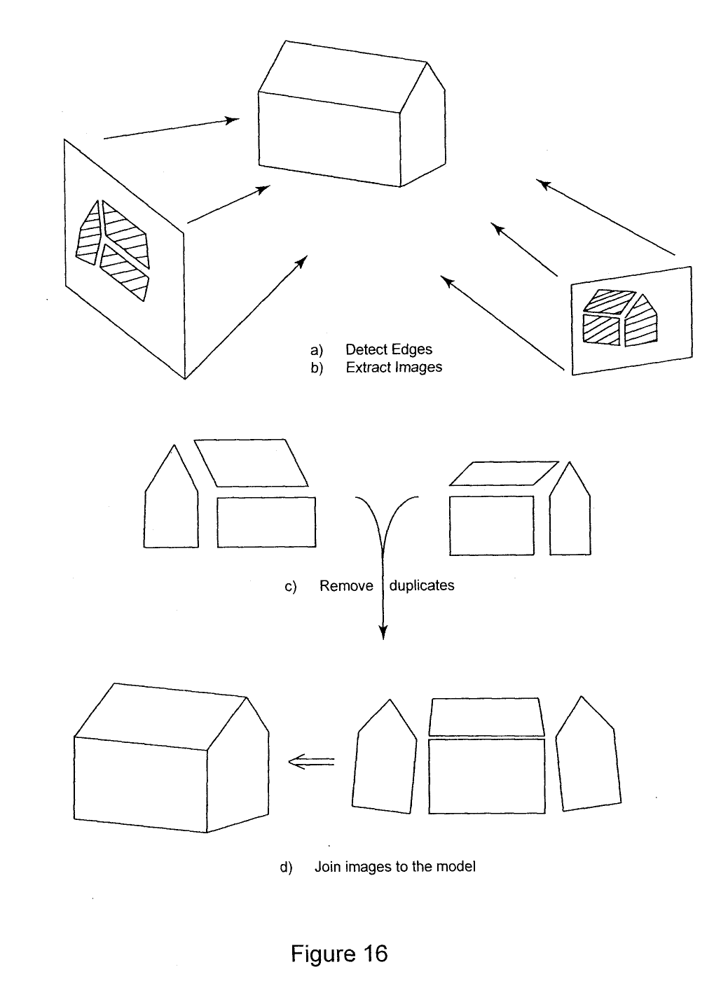

The process of preparing texture image components for draping over building models is shown in FIG. 16.

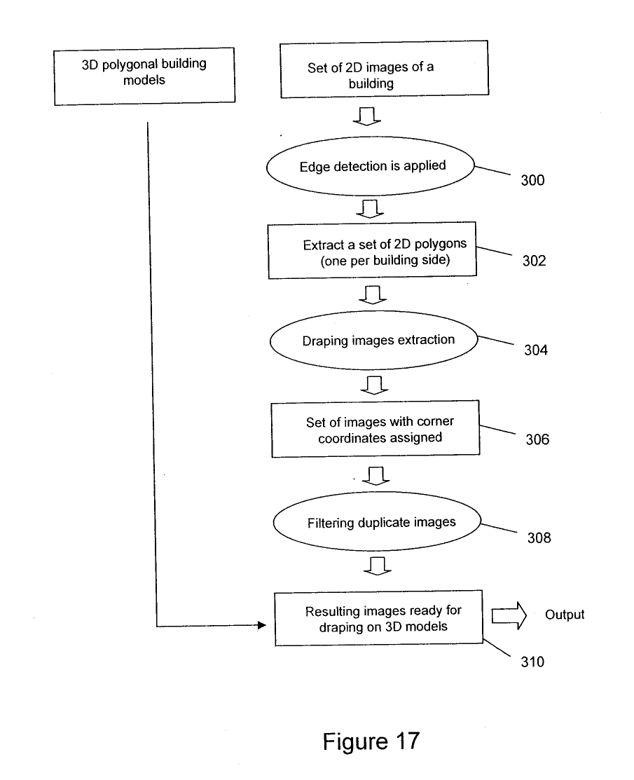

Turning to FIG. 17, example computer executable instructions are provided for preparing texture image components to be draped over 3D polygonal building model facets (e.g. according to module 48). It is assumed that a building polygonal 3D model exists, the building is photographed from several known angles and the digital images (e.g. in tiff format) of the building are geo-referenced and have required resolution to be used as draping textures. At block 300, images representing the building are processed on a computer using an algorithm of edge detection (for example, Sobel Edge Detection). As the result of this processing, one new image is generated with the building's edges highlighted for each input building image.

At block 302, closed contours are extracted from each image with the building's edges in the form of 2D polygons. The number of extracted polygons corresponds to the number of facets that were presented on each building image (for example, in case of a picture taken to capture two sides of a rectangular building, two polygons will be extracted).

At block 304, the draping images are extracted by superimposing each polygon extracted in block 302 on to the building picture used for edge detection and cutting off the inner part of the image surrounded by the polygon. As the result, there will be as many draping pictures extracted as polygons/facets used.

At block 306, 3D coordinates for each draped image corner are assigned based on the geo-referenced position of each image used. The coordinates are saved as metadata information of its respective draping image.

At block 308, geometrical duplicates (i.e. pictures of the same building side) are eliminated by filtering the draping images while comparing and correlating the 3D coordinates stored in their metadata to detect overlap of the images.

At block 310, the remaining images are grouped together with their corresponding 3D building model in a data format suitable for combining them together as a colored model (for example, Google Sketchup can create a colored model by pasting the images onto the building model).

Another aspect of the present invention provides a method of automated pattern recognition used to identify structural elements of a high resolution polygonal 3D building model built out of 3D points. A high resolution polygonal 3D building model built out of 3D points is one logical entity and usually is a shell-like structure.

Even though it is obvious for a human eye to recognize and separate structural elements on the model like doors, windows, ledges, eaves etc., it is quite difficult for a computer system to achieve the same. The present invention simplifies the process of computerized identification of predefined structural elements of a 3D building model. This method can be used as a separate mechanism or as a part of more sophisticated process where it is not only important to determine the presence of certain elements in the model but to actually extract and/or analyze them.

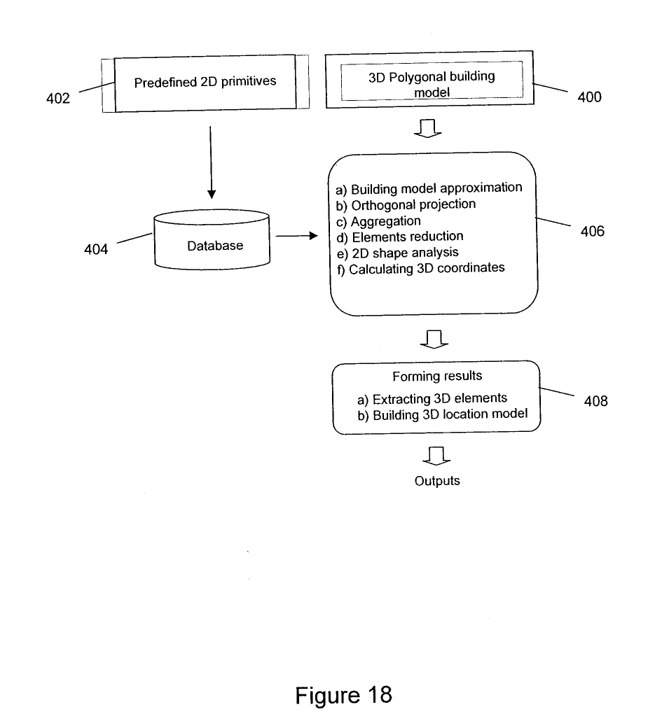

Turning to FIG. 18, example computer executable instructions are provided for automated pattern recognition used to identify structural elements of a high resolution polygonal 3D building model (e.g. according to module 50). It is assumed that a polygonal 3D building model 400 exists which is constructed of 3D spatial data points forming a triangulated network or shell of the outside surface of the building. It is also assumed that the resolution of the model is high enough to be able to recognize small structural elements such as windows, doors, ledges etc. Usually, such a model would need to have a 5 to 10 centimeter resolution or finer (i.e. spatial data points are closer together than this distance).

A set of simple 2D geometrical primitives 402 resides in a database 404 of many possible expected shapes of doors, windows, arches and other structural elements of a building facade. These primitives will be used as pattern recognition templates while analyzing the 3D building model at block 406 to locate and recognize its structural components. The primitives could be squares, rectangles, arches and other 2D primitives. The 2D geometrical primitives only define the typical shape and proportions of an element (such as a door or window) that needs to be found. The size of the actual building structural component can vary and will be determined during the pattern recognition process.

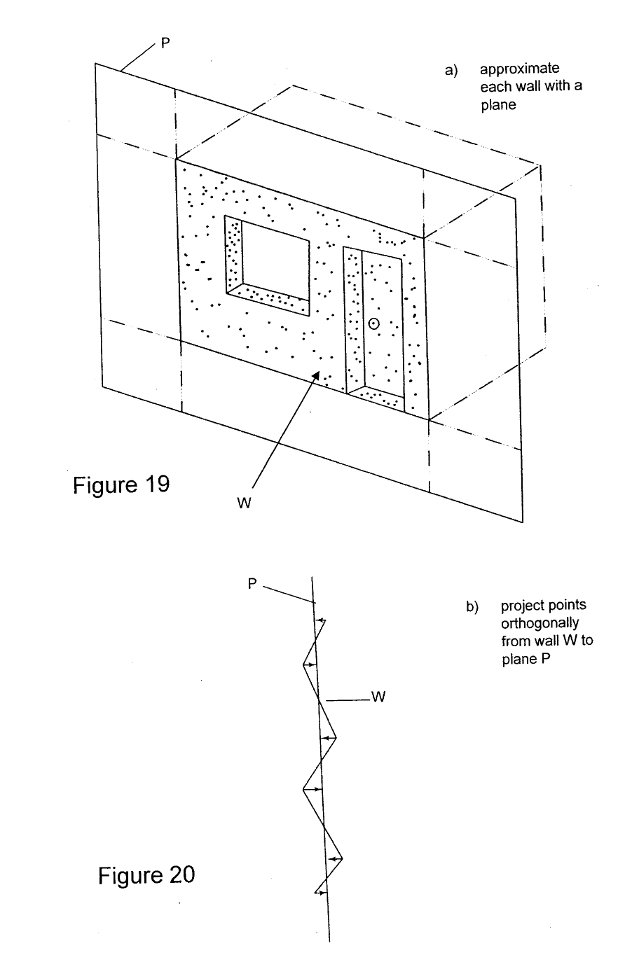

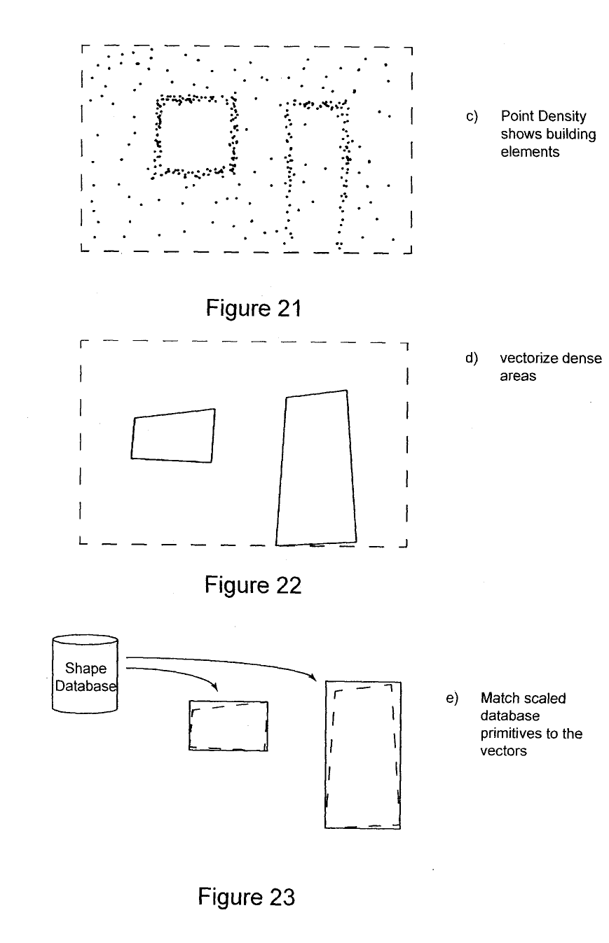

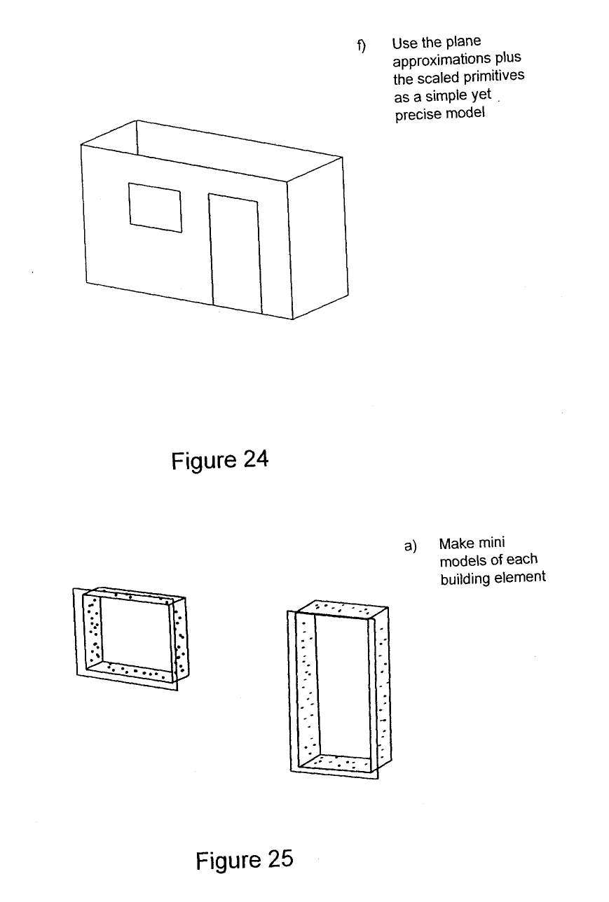

At block 406, the following pattern recognition steps occur:
a. A simplified approximation of the building model is created comprising 2D planes representing the building walls and roof (FIG. 19). The 2D planes can have simple rectangular shapes and are required only as flat surfaces to project other objects onto at block 408. The dimensions and number of these rectangular elements depend on the model complexity and could be as simple as four walls and a single flat roof.
b. Projection of all building points onto the 2D wall planes. For each 2D plane representing a wall, all 3D spatial data points of the building model adjacent to the 2D wall plane are orthogonally projected along with their triangulated network onto the 2D plane (FIG. 20). The projected result will show lines of high point density and high triangle density located especially around window frames, door frames and ledges. These lines form a collection of 2D polygons representing windows, doors and other building elements bounded by the rectangular shape of each wall.
c. By analyzing a density map of the resulting collection of projected points and projected triangles, an aggregation is applied replacing collections of points or collections of triangle vectors in the denser areas with one vector object (i.e. line) which describes the edge of the building element (door or window) (FIG. 21). The same can also be achieved for example by outputting the results from Step b into an image and then performing a density analysis to delineate the dense parts of the image.
d. Step c can be repeated to minimize the remaining number of objects if required until lines representing the edges of doors, windows and other building edifice elements remain (FIG. 22).
e. The database of 2D geometric primitives is now used is now used to find geometric primitives whose shapes and proportions best match the structural element objects generated by Step d (FIG. 23). Scale coefficients can be used to regulate and modify the sizes of elements to be found relative to sizes of predefined primitive shapes.
f. Combine together the results of all the walls to form a model converted into 3D and now consisting of the simplified 2D wall planes on which lie a set of regular geometrical primitives representing the perimeters of building features such as doors, windows and arches (FIG. 24).

Depending on the final task at block 408, the results of block 406 could be used, for example, as follows:
a. If you want a mini model of each building element then iterate through the array of 3D geometrical primitives identified at block 406, using their perimeters expanded by a small amount (for example by 6 inches) to extract all 3D points and/or the triangulated network out of the original source building model. Each resulting model subset will be approximately bounded by the geometric primitive which was used to extract it.
   This will result in a number of 3D mini-models (for each door, window and arch) representing structural elements matching the geometric primitive which was used to extract it (FIG. 25). These models could be used for further analysis or separate rendering.
b. If you want a simplified yet positionally accurate model of the building then use the new 3D version (FIG. 24) comprised of the simplified 2D wall planes on which is a collection of regular geometric primitives.
   This will result in a more compact model which can be drawn faster and disseminated faster yet still represent the actual positions of the buildings and building features. This model can be used in combination with the initial 3D building model for further analysis.

Another embodiment of the present invention provides a method of automated enhancing of 3D building model by replacing similar 3D structural elements with prebuilt models (templates) of the element or with “the best” model (template) of the element. A high resolution polygonal 3D building model constructed out of 3D points is regarded as one logical entity and usually is a shell-like structure. When the model is built based on irregular data points, similar structural elements of the model (windows, doors, ledges, eaves etc.) usually have non identical shape or geometry due to the irregular nature of the input data used. Also some features (such as windows) could have been partially obstructed by objects (such as tree branches) causing parts of the building model to be incomplete.

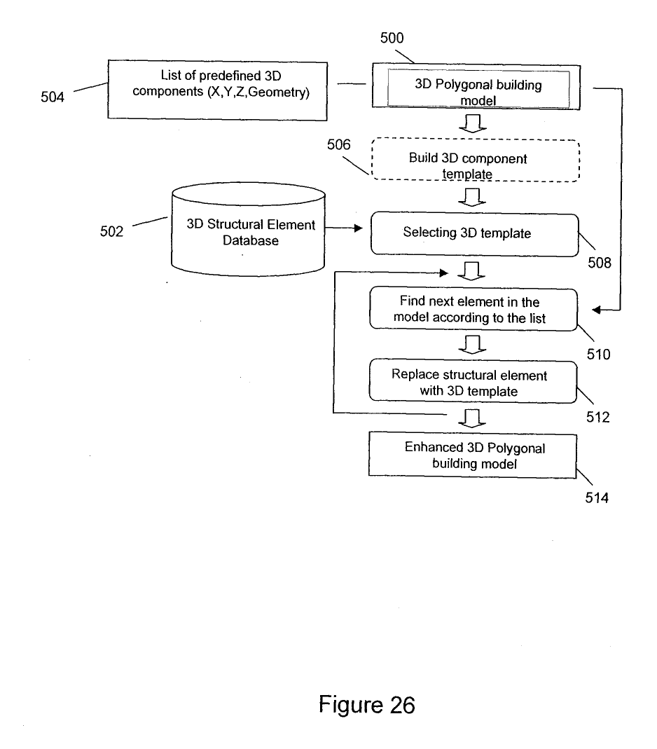

Turning to FIG. 26, example computer executable instructions are provided for automating the process of computerized 3D building model enhancement by replacing similar 3D structural elements in the model with a pre-built template of that element (e.g. according to module 52). This allows creating a building model that is much closer to reality and geometrically correct.

It is assumed that a polygonal 3D building model 500 constructed of 3D points exists. It is also assumed that for each type of structural element (e.g. door or window) there is a number of very similar if not identical mini-models (having positional coordinates, geometry type and data points) of building structural elements to be replaced with a predefined 3D element template (stored in list 504).

When no prebuilt 3D element template exists, then “the best” one on the building model could be selected at block 506 (optional) to act as the template using the following technique. For each group of similar structural element mini-models of a particular building, select a suitable candidate which “best” depicts that structural element based on a criterion. For example the one having the highest average density of points could be taken to serve as the template to replace all elements of the same type within the 3D building model.

At block 508, a 3D template element is selected to be used to replace structural elements of a given type from either the template identified at block 506 or use a pre-saved template selected from a number of templates stored in a database 502 and prepared in advance based on existing industry standards.

At block 510, the positional coordinates, geometry type and data points (mini-model) of the next structural element from the input list 504 of the group being considered is located in the 3D model.

At block 512, the structural element found at block 510 is replaced with the 3D template defined at block 508. This involves the following operations:
a. Delete all model edges (elements) found at block 510 connecting the structural element from the building model.
b. Replace the disconnected structural element with the 3D template defined at block 508 shifted and oriented into the same position as the deleted one.
c. Connect 3D template to the building model by recreating triangulation network linking the closest in space nodes of the model and the template.

Block 510 and block 512 are repeated until all structural elements defined in the input list are replaced with the selected 3D template.

At block 514, the initial 3D building model is replaced with the one now having standard structural components integrated into it.

Another aspect of the present invention provides a method for automated identification of a moving object as a result of extraction of 3D objects out of a LiDAR point cloud processed on a computer.

The idea is to be informed by a system when one of a set of predefined objects moves into the area that is being scanned or when one of a set of predefined objects is removed from the area being scanned. It is achieved by analyzing two sequential LiDAR data sets received from the scanner, finding a difference by using a known change detection technique, building 3D models of change detected points, comparing built 3D models with predefined models of objects to be identified, and signalling when the match is found. The method assumes that the laser scanning density is sufficient enough to model and recognize 3D objects of certain size.

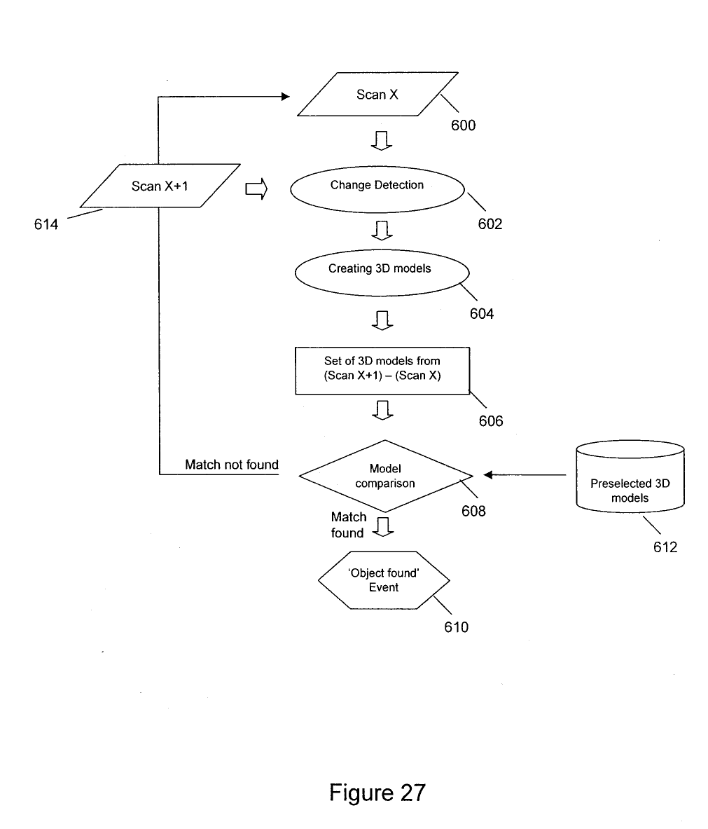

Turning to FIG. 27, example computer executable instructions are provided for automated identification of a moving object (e.g. according to module 54). LiDAR data (point clouds) is collected by periodical laser scanning of an area. The interval between scans may vary depending on the application, laser hardware characteristics and speed of the data processing.

At block 602, data coming from sequential scanning is processed using the change detection algorithm, which identifies areas of points that are different in the current data set 614 to compare to the previous scan result 600. Depending on the software and hardware used for the change detection, this process can be done in real time or in a post-processing mode. As the result of this step, the detected change (i.e. subsets of LiDAR points that were considered as a change) is cashed for further analysis. A simple example of such a change detection algorithm is to find all the data points in the current data set which are more than 6 inches from any point in the previous data set, and also to find all the data points in the previous data set which are more than 6 inches from any point in the current data set. The results can represent possible objects that may have been added and possible objects that may have been removed between the two epochs of the two data sets. When both occur together with a similar object, the movement of an object may be inferred.

At block 604, subsets of LiDAR points detected at block 602 are converted into 3D vector models 606, for example using triangulation technique.

At block 608, 3D models 606 built at block 604 are compared with pre-selected target 3D models stored in a database 612 and targeted for identification. Comparison can be done for one or several models depending on target identification requirements. If a match is found, an alarm signal 610 is sent by the system along with the ID of the model that was found. If several matches are found the correspondent information is sent accordingly.

If the identification was positive, depending on particular requirements, the process could be stopped on this step or continue. If no match was found at block 608, the current scanned and processed LiDAR data set 614 is considered as a base 600 and the next scanned data set is taken into the process starting from block 602.

Another aspect of the present invention provides a method for extracting poles along the roads from point cloud data. A “pole” is defined as an object which has predefined height limits and predefined base square limits. Broadly speaking, many other objects and features (for example from fire hydrants to pedestrians) can be extracted in a similar way by varying the dimensions of the criteria. One assumes that all poles are located as separate stand alone objects and are separated from other objects by a sector of bare earth.

The method of extracting poles along a road is based on the classification of spatial data points located over the earth surface (including the surface of the road) and on the analysis of the distribution of these points. In order to reconstruct the shape of the pole it is suggested to use the model of prism which has a horizontal base and vertical walls.

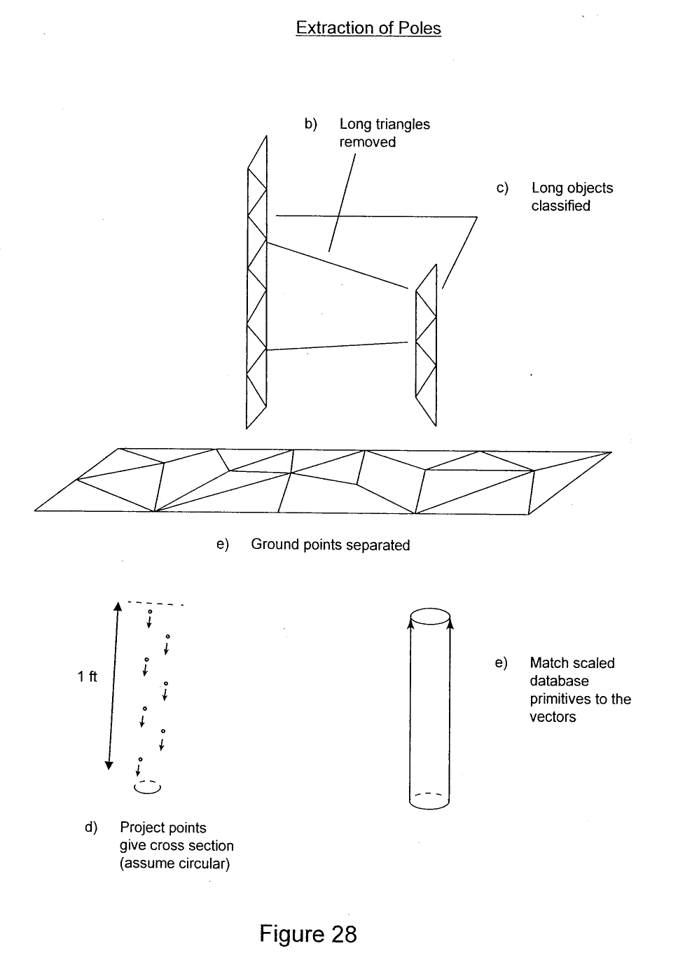

To extract the poles, the spatial data points located above the ground must be separated from those comprising the ground surface. Individual objects must then be located within the above-ground data points and each individual object must be analyzed and classified according to the class of poles. Each pole shape is then re-constructed. The process to extract poles is shown in FIG. 28.

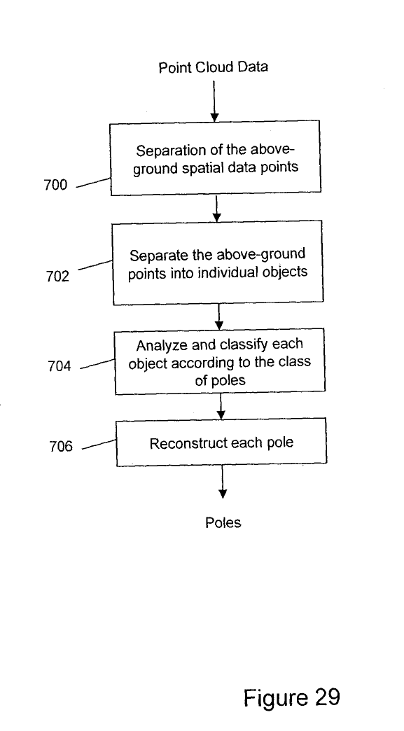

Turning to FIG. 29, example computer executable instructions are provided for extracting poles along the roads from mobile point cloud data (e.g. according to module 56). The spatial data points located above the ground must be separated from those comprising the ground surface. At block 700, the input collection of spatial data points such as laser scanned aerial and mobile LiDAR data must be preprocessed to identify and extract an approximate ground surface and associated Digital Terrain Model for the whole area of interest. Examples of these procedures are described in associated patent applications previously mentioned. The remaining set of points describes features above the ground surface.

Note that, especially in highway situations, points can often be collected at several horizontal levels (such as multiple raised highways especially around clover leaf intersections). In this case the above-ground points may have to be reprocessed in multiple iterations, each pass separating another level to be regarded as “ground”. After multiple iterations the ground points from all iterations can be merged together into a single “ground” class. All other points would then be regarded as “above-ground” data points.

Individual objects must then be located within the above-ground data points. At block 702, a triangulation network is built using the above-ground points. Long edges are deleted from the triangulation network to remove false connections (such as gaps between parallel wires) and to separate objects that are not supposed to be connected (such as parallel vertical poles). The threshold for edge length is defined according to the density of data and should be several times longer than the average distance between points. The latter can be approximated, for example, as the square root of a number which is the area of the region of interest divided by the number of data points.

By deleting the long edges the triangulation network gets broken down into a number of local sub-networks which can then be analyzed separately.

Each individual object must be analyzed and classified by their dimensions according to the classes of poles and other objects. At block 704, the separated groups of points are now sorted and categorized according to the horizontal area they cover, by their linear size and by the number of points inside each group. To represent each type of object, such as a pole, with certainty it is assumed that some minimum threshold number of points is required in the representation. Otherwise the group of points will be treated as “noise”.

For all groups of points which pass this filtering process one calculates the height and the area of horizontal cross-section at certain step intervals (for example one foot intervals) along the height. If the required criteria satisfy the pre-defined limits (for example a four to six inch diameter along its length) the object is classified as a “pole”

At block 706, each pole is reconstructed. The pole shape can be assembled from the vertical prisms or the triangulated network but may likely have changeable horizontal cross-section areas along its length if the data points are sparse. In order to assess the cross-section area more reliably, one selects the data points from a certain interval of heights (for example each foot of height), projects them to the horizontal plane and builds a 2D convex hull of their projections. Then one constructs a prism with the defined base (for example the convex hull best fit to a circle) and having a height equal to the chosen vertical step along the height of the pole (for example one foot). Consequently one builds the complete model of the vertical pole.

It can be appreciated that many of the above operations can be combined. For example, upon constructing a building model (e.g. using module 45), the building's color is determined (e.g. using module 46). Texture of the building from images may also be draped over the building model (e.g. using module 48). Then 3D structural elements of the building model may be identified (e.g. using module 50). The identified 3D structural elements can be replaced with ideal or standardized structural elements, thereby enhancing the building model (e.g. using module 52). If an object on the building has changed or moved, such as an extension to the building, that object will be identified (e.g. using module 54). Any poles surrounding the building can also be extracted and identified (e.g. using module 56).

The steps or operations in the flow charts described herein are just for example. There may be many variations to these steps or operations without departing from the spirit of the invention or inventions. For instance, the steps may be performed in a differing order, or steps may be added, deleted, or modified.

While the basic principles of this invention or these inventions have been herein illustrated along with the embodiments shown, it will be appreciated by those skilled in the art that variations in the disclosed arrangement, both as to its details and the organization of such details, may be made without departing from the spirit and scope thereof. Accordingly, it is intended that the foregoing disclosure and the showings made in the drawings will be considered only as illustrative of the principles of the invention or inventions, and not construed in a limiting sense.

1. A method for extracting features of a building from data having spatial coordinates, the method comprising:
extracting one or more walls and roofs from the data
constructing a building model from the walls and roofs
extracting color data associated with the data and projecting the color data onto the building model;
superimposing one or more images onto the building model;
applying pattern recognition to extract one or more three-dimensional structural components of the building model;
upon identifying a match between the extracted three-dimensional structural components and one or more standard structural elements, the standard structural elements stored in a structural elements database, then replacing the extracted three-dimensional structural components with the standard structural elements;
upon capturing a subsequent set of data having spatial coordinates of the building, comparing the data with the subsequent data to identify a changed object; and,
extracting one or more poles in the building model's vicinity or along edges of roads.
